(19) United States
(12) Patent Application Publication
(10) Pub. No.: US 2012/0215870 A1
(43) Pub. Date: Aug. 23, 2012

(54) Method and System for Implementing Time Processing of Message

(75) Inventors: Yejuan Zhou, Shenzhen (CN); Bing Ye, Shenzhen (CN); Jian Zhong, Shenzhen (CN)

(73) Assignee: ZTE CORPORATION, Shenzhen, GD (CN)

(21) Appl. No.: 13/505,212

(22) PCT Filed: Dec. 25, 2009
(86) PCT No.: PCT/CN2009/076078

§ 371 Date: Apr. 30, 2012

(30) Foreign Application Priority Data
Oct. 30, 2009 (CN) 200910110448.8

(51) Int. Cl. G06F 15/16

(52) U.S. Cl. 709/206

(57) ABSTRACT

A method and a system for implementing time processing of a message are provided in the present invention. The method includes: when determining that the time information in the received message needs to be processed according to a customized mode, performing the time conversion on the message according to the customized mode; distributing the message after the time conversion. The time information in the message can be processed according to the customized mode, thereby enabling the message, based on the actual requirements of the user terminal, to be displayed in manner of flexible time format, avoiding a confusion of the message time for the user and ensuring a better development of user message services.

### FIELD OF THE INVENTION

The present invention relates to the field of mobile communication technologies, and in particular to a method and a system for implementing time processing of a message.

### BACKGROUND OF THE INVENTION

A message transmitted from a message center to a receiving terminal carries time information which is used for the receiving terminal to recognize when the message is transmitted from a transmitting terminal.

According to a Global System for Mobile Communication (GSM) protocol, the time information carried in the message comprises: message center time and time zone identifier. If the receiving terminal supports a time zone function, after receiving the message, the receiving terminal would analyze the time as the time based on the current time zone of the receiving terminal itself and then display the time.

According to a Code Division Multiple Access (CDMA) protocol, the time information carried in the message has no associated time zone identifier, only indicating that the time is based on Universal Time Coordinated (UTC). In a new version of CDMA protocol, it is indicated that the time is based on UTC or based on user time. However, during implementation, the time information generally is based on a Local time of the message center.

When the receiving terminal and the message center are located in different time zones, or when the receiving terminal roams to a different time zone, after the time information based on the time zone of the message center is transmitted to the receiving terminal, the time displayed by the GSM terminal not supporting the time zone function and the CDMA terminal not carrying a time zone identifier may be inaccurate, which would impact the analysis of the message transmitting time for the receiving user; particularly for the message having a close relationship with time, the inaccuracy of time would cause a great influence to the user.

The prior art has taken the problems above into consideration, and the process manners comprise the following points or combination thereof: (1) based on the time zone of the message center; (2) based on the time zone of a home location of the receiving terminal; (3) based on the time zone of a currently visited Mobile Switching Center (MSC) of the receiving terminal.

The defects of the prior art lie in that: when the transmitting time of the message is filled in the message, it is the message center that determines the time is based on the time zone of the message center, or the time zone of the home location of the receiving terminal, or the time zone of the visited MSC of the receiving terminal. Therefore, after the message is delivered to the receiving terminal, the receiving terminal still can not determine which time zone the time is based on, there still exists a time zone confusion phenomenon, besides, the display modes of all receiving terminals are the same, thus it is inconvenient for a user to perform a flexible modification based on his/her actual requirement.

### SUMMARY OF THE INVENTION

The present invention provides a method and a system for implementing time processing of a message, so as to avoid a confusion of the message time for a user and ensure a better deployment of user message services.

The technical solution of the present invention is realized as follows.

The present invention provides a method for implementing time processing of a message, comprising the steps of

when determining that time information in a received message is required to be processed according to a mode customized by a user, performing time conversion for the message according to the mode customized by the user; and

delivering the message subjected to the time conversion.

The method further comprises the steps of:

receiving information for customization of the user; and

obtaining the mode customized by the user according to the information for customization of the user.

The method further comprises the steps of:

receiving information for modifying customization of the user; and

obtaining a customized mode modified by the user according to the information for modifying customization of the user.

The method further comprises the steps of:

receiving information for canceling customization of the user; and

canceling the mode customized by the user according to the information for canceling customization of the user.

The method further comprises a step of: making the information for customization of the user one part of account information of the user.

The method further comprises a step of: making the time conversion a value-added service of the user.

The mode customized by the user comprises: based on Universal Time Coordinated (UTC), based on Local time of a message center, based on time of an account-opening location of the user or based on time of a visited Mobile Switching Center (MSC) of the user.

The present invention also provides a system for implementing time processing of a message, comprising:

a message center processing system, configured to receive a message, determine that time information in the message is required to be processed according to a mode customized by a user and transmit the message subjected to time conversion; and

a message time processing system, configured to perform the time conversion for the message according to the mode customized by the user.

The message time processing system is integrated into a value-added service platform, or the message time processing system is integrated with the message center processing system.

The message time processing system is further configured to receive information for customization of the user and obtain the mode customized by the user according to the information for customization of the user.

The message time processing system is further configured to receive information for modifying customization of the user and obtain a customized mode modified by the user according to the information for modifying customization of the user.

The message time processing system is further configured to receive information for canceling customization of the user and cancel the mode customized by the user according to the information for canceling customization of the user.

The message time processing system is further configured to synchronize the information for customization of the user, or the information for modifying customization of the user or the information for canceling customization of the user to the message center processing system.

In virtue of the method and the system for implementing time processing of a message provided in the present invention, the time information in the message can be processed according to a mode customized by the user, so as to enable the message to be displayed in a manner of flexible time format based on the actual requirements of a user terminal, avoid a confusion of the message time for the user and ensure a better deployment of user message services.

### BRIEF DESCRIPTION OF THE DRAWINGS

FIG. 1 shows a schematic diagram of a system architecture applied in an embodiment of the present invention;

FIG. 2 shows a schematic diagram of another system architecture applied in an embodiment of the present invention;

FIG. 3 shows a schematic diagram of a third system architecture applied in an embodiment of the present invention;

FIG. 4 shows a message flowchart in accordance with an embodiment of the present invention;

FIG. 5 shows a schematic diagram of the principle of converting time according to a user specified format in accordance with an embodiment of the present invention; and

FIG. 6 shows a schematic diagram of the principle of flexibly setting a time format by a user according to requirements in accordance with an embodiment of the present invention.

### DETAILED DESCRIPTION OF THE EMBODIMENTS

The implementation of the present invention is further illustrated below in detail in conjunction with accompanying drawings. In order to avoid a confusion of the message time for a user and ensure a better deployment of user message services, the embodiments of the present invention provide a system for processing time of a message, comprising: a message center processing system and a message time processing system.

The message center processing system stores and forwards a message. In addition, the message center processing system records message time and a corresponding time zone, requests and records an address of an MSC to which the message is delivered, delivers the message carrying the information above to the message time processing system, receives the message subjected to the time processing performed by the message time processing system and then delivers this message.

The process whether the message center processing system delivers the message to the message time processing system needs to be determined according to a configuration and a service activation condition of a receiving terminal.

If the message center processing system is configured to adjust time information according to the receiving terminal and it is determined that the receiving terminal has activated the related service, the message center processing system delivers the message to the message time processing system. If it is judged that the message is not required to be delivered to the message time processing system, time is processed according to the default configuration of UTC or Local time format of the message center processing system.

According to a currently configured time display mode of the receiving terminal, the message time processing system matches relevant stored information, performs time conversion for the message and returns the message subjected to time processing to the message center processing system.

The time display mode of the receiving terminal, that is, a time display mode of the user, comprises but not limited to: based on UTC time, based on Local time of the message center, based on time of an account-opening location of the user, or based on time of a visited MSC of the user, etc.

The relevant stored information in the message time processing system comprises: a time zone of the message center processing system, corresponding relationship between the MSC and a time zone, a time zone of the account-opening location of the user, service information for maintaining the time display mode of the user, etc.

The service information for maintaining the time display mode of the user comprises: customization, modification, cancellation, etc., wherein the customization and the cancellation functions enable the user to activate and cancel the service through a terminal or web operation; and the modification function enables the user to modify the time display mode through a terminal or web operation.

Preferably, the customization, modification and cancellation operations of the service (that is, maintaining the time display mode of the user) performed by the user can be synchronized to the message center processing system through a message or a file, so that the message center processing system determines whether it is required to transmit the message to the message time processing system to process.

If the overhead of the message interaction between the message center processing system and the message time processing system is not taken into consideration, the customization, modification and cancellation operations of the related service of the user might not be synchronized to the message center processing system, in this case, only if the message center processing system activates the function of adjusting time information according to the receiving terminal, all messages are required to be transmitted to the message time processing system to process.

Correspondingly, the message time processing method in accordance with an embodiment of the present invention comprises processing as follows.

Through a terminal or a web platform, a user customizes and activates a service function of performing message time processing according to a user-defined mode and sets a corresponding time display mode, for example, based on UTC time, based on Local time of a message center, based on time of an account-opening location of the user, or based on time of a visited MSC of the user, etc.

The message center processing system receives a message, records message time and a corresponding time zone according to a default time display mode, and meanwhile requests and records an MSC address to which the message needs to be delivered.

If the message center processing system is not configured with the service function of performing message time processing according to a user-defined mode of a receiving terminal, or the receiving terminal has not activated the related service, the message center processing system directly delivers the message based on the above time recorded according to the default time display mode; if the receiving terminal is a GSM terminal, the delivered message carries time zone information simultaneously. If it is judged that the message is required to be transmitted to the message time processing system, the message carrying information, such as recorded time, related time zone and visited MSC address, is delivered to the message time processing system.

According to the currently defined time display format of the receiving terminal, the message time processing system searches the stored time zone information of the message center processing system, or the information of a corresponding relationship between MSC and time zone, or time zone information of the account-opening location of the user, performs time conversion for the message and returns the message subjected to time processing to the message center processing system.

The message center processing system delivers the message subjected to time processing to the receiving terminal.

If the overhead of the message interaction between the message center processing system and the message time processing system is not taken into consideration, during implementation, all messages can be transmitted to the message time processing system uniformly, without the previous process of judging whether the user has activated the related service in the message center processing system.

In another implementation, the message time processing system is embedded in a value-added service platform (for example, user value-added service system), the time conversion processing, as a value-added service of a user, is realized and managed by the value-added service platform uniformly.

There is a third implementation, in which, the message time processing system can be embedded in the message center processing system, the configuration of the time display mode of the user can be regarded as one part of the account information of the user and can be directly managed by the message center processing system which performs time conversion according to user requirements.

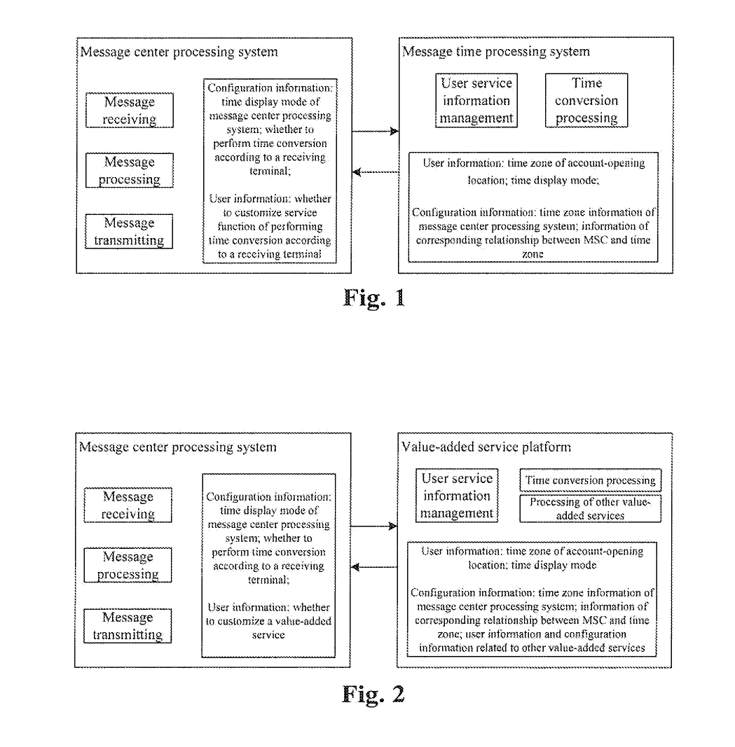

FIG. 1 shows a schematic diagram of a system architecture applied in an embodiment of the present invention. The system comprises a message center processing system and a message time processing system.

The message center processing system receives a message, records message time and a corresponding time zone, requests and records an address of an MSC to which the message is delivered, delivers the message carrying the information above to the message time processing system, receives the message subjected to time processing performed by the message time processing system and then delivers this message.

The process whether the message center processing system delivers the message to the message time processing system is determined according to a system configuration and a service activation condition of a receiving terminal.

If the message center processing system is configured to adjust time information according to the receiving terminal and it is determined that the receiving terminal has activated the related service, the message center processing system delivers the message to the message time processing system. If it is judged that the message is not required to be delivered to the message time processing system, time is processed according to the default configuration of UTC or Local time format of the message center processing system.

The message time processing system performs time conversion for the message according to currently configured time display mode of the receiving terminal and the relevant stored information, and returns the message subjected to time processing to the message center processing system.

The time display mode of the user comprises: based on UTC time, based on Local time of the message center, based on time of an account-opening location of the user, or based on time of a visited MSC of the terminal, etc.

The relevant stored information comprises: stored time zone information of the message center processing system, stored information of a corresponding relationship between the MSC and a time zone, stored time zone information of the account-opening location of the user, service information for maintaining the time display mode of the user, etc.

The service information for maintaining the time display mode of the user comprises: customization, modification and cancellation, wherein the customization and the cancellation functions enable the user to activate and cancel the service through a terminal or web operation; and the modification function enables the user to modify the time display mode through a terminal or web operation.

The customization, modification and cancellation operations of the service performed by the user can be synchronized to the message center processing system through a message or a file, so that the message center processing system determines whether it is required to transmit the message to the message time processing system to process.

The synchronization information does not need to comprise specific details of the service. The message center processing system only needs to concern whether the user has activated or canceled the service.

If the overhead of the message interaction between the message center processing system and the message time processing system is not taken into consideration, during, implementation, all messages can be transmitted to the message time processing system uniformly, without the previous process of judging whether the user has activated the related service in the message center processing system, also without synchronizing the service information of the user between the message center processing system and the message time processing system.

FIG. 2 shows a schematic diagram of another system architecture applied in an embodiment of the present invention. In this implementation, the time conversion processing, as a value-added service of a user, is uniformly realized and managed by the value-added service platform.

The implementation logic is basically consistent with that in FIG. 1, with a slight difference, wherein the difference lies in that: when the message center processing system forwards the message to the value-added service platform, the message center processing system can determine only whether the user has a value-added service without determining the specific service.

Such process can be realized by modifying and expanding the existing value-added service platform, which is convenient to implement.

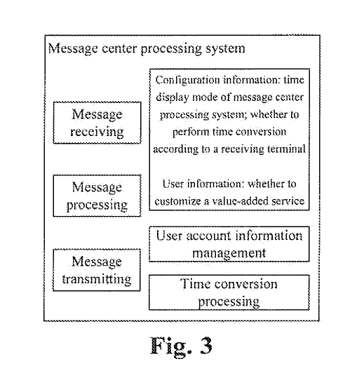

FIG. 3 shows a schematic diagram of a third system architecture applied in an embodiment of the present invention. In this implementation, the message time processing system is embedded in the message center processing system directly.

The configuration of the time display mode of the user, which is regarded as one part of the account information of the user, is directly managed by the message center processing system which performs time conversion according to user requirements.

The account information of the user further comprises time zone information of the account-opening location.

The message center processing system further needs to store: whether to initiate the function of performing time conversion according to the configuration of the user; and a corresponding relationship between an MSC address and the time zone.

The principle of time conversion is consistent with the above.

Such process can be applied to the conditions of no value-added service platform and not planning to add other equipment, which is convenient to implement.

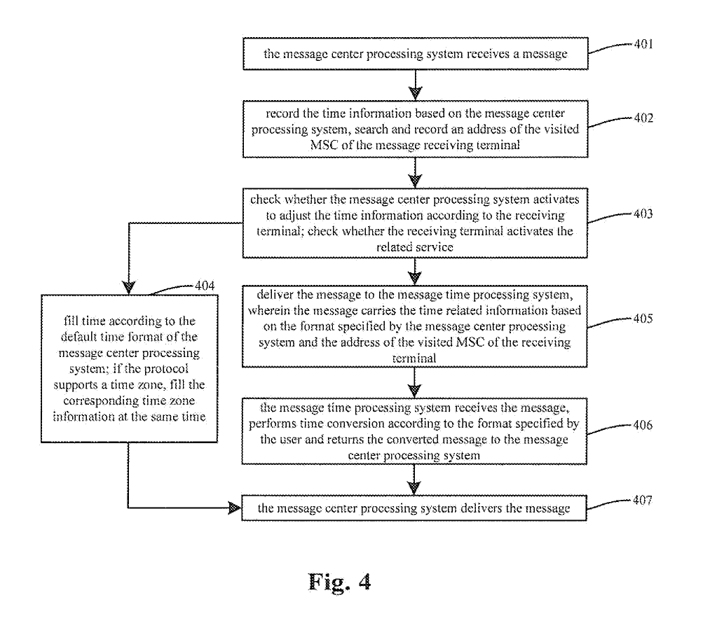

FIG. 4 shows a message flowchart in accordance with an embodiment of the present invention. The flow comprises steps as follows.

Step 401: a message center processing system receives a message.

Step 402: the message center processing system records the message time and a corresponding time zone according to a default time display mode of the system, and meanwhile requests and records an MSC address to which the message is transmitted. That is, the message center processing system records the time information based on the message center processing system, searches and records the address of the visited MSC of the message receiving terminal.

The default time display mode of the system can be configured as the OTC time or the Local time of the message center processing system.

Step 403: it is checked whether the message center processing system activates the function of adjusting the time information according to the receiving terminal and whether the receiving terminal activates the related service, if yes, execute Step 404; otherwise, execute Step 405.

During implementation, the checking of the service activation condition of the receiving terminal might not be performed, and all messages are delivered to the message time processing system to process.

Step 404: if the system is not configured with the function or the user of the receiving terminal has not activated the service, the time is filled according to the default time display mode of the message center processing system; if the protocol supports a time zone, the corresponding time zone information is filled at the same time, then go to Step 407.

Step 405: the message is delivered to a message time processing system, wherein the message carries time and time zone information based on the format specified by the message center processing system and the address of the visited MSC of the receiving terminal.

Step 406: the message time processing system receives the message, converts the time according to the format specified by the user and returns the converted message to the message center processing system.

Step 407: the message center processing system delivers the message.

Particularly, when the message time processing system is embedded in a value-added service platform system, the interaction between the message center processing system and the message time processing system becomes the interaction between the message center processing system and the value-added service platform; and when the message time processing system is embedded in the message center processing system, the interaction between the message center processing system and the message time processing system becomes the internal processing of the message center processing system.

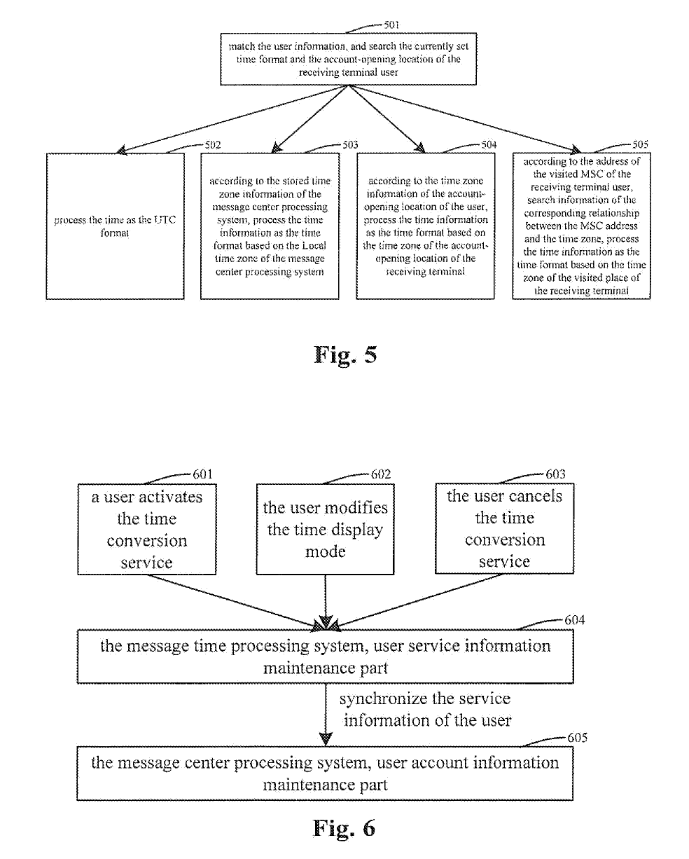

FIG. 5 shows a diagram of the principle of converting time according to a user specified format in accordance with an embodiment of the present invention. The procedure comprises steps as follows.

Step 501: user information of a receiving terminal is read, wherein the user information comprises a time zone of an account-opening location and a currently set time conversion mode. That is, the user information is matched to search for the currently set time format and an account-opening location of the user of the receiving terminal.

Step 502: if it is set to deliver based on the format of the UTC time, the time is directly processed as the UTC format.

Step 503: if it is set to deliver based on the format of the Local time of the message center processing system, the stored time zone information of the message center processing system is searched, and the time information is processed as the time format based on the Local time zone of the message center.

Step 504: if it is set to deliver based on the time format of the account-opening location of the user, according to the time zone information of the account-opening location of the user, time conversion is performed to process the time as the time format based on the time zone of the account-opening location of the receiving terminal.

Step 505: if it is set to deliver based on the time format of the visited place of the user, according to the address of the visited MSC of the receiving terminal user, information of the corresponding relationship between the MSC address and the time zone is searched, and time conversion is performed to process the time as the time format based on the time zone of the visited place of the receiving terminal.

FIG. 6 shows a diagram of the principle of a user flexibly setting a time format according to requirements in accordance with an embodiment of the present invention.

According to the time zone supporting condition of a user terminal, the user sets a time display mode according to requirements. In this way, after a message is transmitted to the terminal, the time will not be wrong or confused for the user.

Provided that the user terminal does not support time analysis based on a time zone, the user originally displays time according to the time zone format of the account-opening location, when the user goes to other places on business, if the user expects to display time according to the time zone format of the visited place, the user can transmit a message by way of a terminal or web to set the message, time to be displayed according to the time zone format of the MSC of the visited place. When the user returns to the account-opening location, the user can set to display time according to the time format of the account-opening location again; even if the user dose not modify the setting, since the initial setting of the user is known, after the message is received, the correct time still can be analyzed.

Step 601: when the user needs to activate the service of converting display time according to the setting, the user transmits a message to the message time processing system in a predetermined message format through a terminal or web, to customize the service, wherein the message can carry an initial time conversion format, or, the message time processing system can initialize a reasonable default time conversion format.

Step 602: when the user needs to modify the time display mode, the user transmits a message to the message time processing system in a predetermined message format of the system through a terminal or web, to perform format modification.

Step 603: when the user does not need the service, the user transmits a message to the message time processing system in a predetermined message format through a terminal or web, to perform service cancellation.

Step 604: the message time processing system maintains the service information of the user according to the message from the user.

Step 605: the message time processing system synchronizes the service information to the message center processing system according to requirements.

When the time conversion process is embedded in the message center processing system or a value-added service platform, the principle is the same as the above.

The above are only embodiments of the present invention, it should be noted that for those skilled in the art, various modifications and improvements can be made without departing from the principle of the present invention, these modifications and improvements are deemed to be included within the protection scope of the present invention.

1. A method for implementing time processing of a message, comprising the steps of:
when determining that time information in a received message is required to be processed according to a mode customized by a user, performing time conversion for the message according to the mode customized by the user; and
delivering the message subjected to the time conversion.

2. The method according to claim 1, further comprising the steps of:
receiving information for customization of the user; and
obtaining the mode customized by the user according to the information for customization of the user.

3. The method according to claim 2, further comprising the steps of:
receiving information for modifying customization of the user; and
obtaining a customized mode modified by the user according to the information for modifying customization of the user.

4. The method according to claim 2, further comprising the steps of:
receiving information for canceling customization of the user; and
canceling the mode customized by the user according to the information for canceling customization of the user.

5. The method according to claim 2, further comprising a step of: making the information for customization of the user one part of account information of the user.

6. The method according to claim 1, further comprising a step of: making the time conversion a value-added service of the user.

7. The method according to claim 1, wherein the mode customized by the user comprises: based on Universal Time Coordinated (UTC), based on Local time of a message center, based on time of an account-opening location of the user or based on time of a visited Mobile Switching Center (MSC) of the user.

8. A system for implementing time processing of a message, comprising:
a message center processing system, configured to receive a message, determine that time information in the message is required to be processed according to a mode customized by a user and transmit the message subjected to time conversion; and
a message time processing system, configured to perform the time conversion for the message according to the mode customized by the user.

9. The system according to claim 8, wherein the message time processing system is integrated into a value-added service platform, or the message time processing system is integrated with the message center processing system.

10. The system according to claim 8, wherein the message time processing system is further configured to receive information for customization of the user and obtain the mode customized by the user according to the information for customization of the user.

11. The system according to claim 8, wherein the message time processing system is further configured to receive information for modifying customization of the user and obtain a customized mode modified by the user according to the information for modifying customization of the user.

12. The system according to claim 8, wherein the message time processing system is further configured to receive information for canceling customization of the user and cancel the mode customized by the user according to the information for canceling customization of the user.

13. The method according to claim 10, wherein the message time processing system is further configured to synchronize the information for customization of the user, or the information for modifying customization of the user or the information for canceling customization of the user to the message center processing system.

14. The:method according to claim 3, further comprising a step of: making the information forcustomization of the user one part of account information of the user.

15. The method according to claim 4, further comprising a step of: making the information for customization of the user one part of account information of the user.

16. The method according to claim 11, wherein the message time, processing system is further configured to synchronize the information for customization of the user, or the information for modifying customization of the user or the information for canceling customization of the user to the message center processing system.

17. The method according to claim 12, wherein the message time processing system is further configured to synchronize the information for customization of the user, or the information for modifying customization of the user or the information for canceling customization of the user to the message center processing system.
